(19) United States
(12) Patent Application Publication
(10) Pub. No.: US 2017/0054726 A1
(43) Pub. Date: Feb. 23, 2017

(54) METHOD AND SYSTEM FOR PROVIDING ACCESS TO AN ONLINE RESOURCE

(71) Applicant: Ziggeo, Inc., New York, NY (US)

(72) Inventor: Oliver Friedmann, New York, NY (US)

(73) Assignee: Ziggeo, Inc., New York, NY (US)

(21) Appl. No.: 15/206,409

(22) Filed: Jul. 11, 2016

Related U.S. Application Data
(60) Provisional application No. 62/190,462, filed on Jul. 9, 2015.

(51) Int. Cl. H04L 29/06; G06Q 30/02; G06Q 20/10; G06F 21/10

(52) U.S. Cl. CPC H04L 63/10; G06F 21/10; G06Q 30/0283; G06Q 20/10; G06Q 2220/00

(57) ABSTRACT

A system and method is provided for accessing content by clients of one or more resources located among one or more resource providers. In one implementation, clients are granted access to resources on the resource provider without the need for communication to the resource provider apriori using distributed authorization tokens. In one example, access control to the resources is handled by an independent server.

### RELATED APPLICATIONS

This application claims priority under 35 U.S.C. §119(e) to U.S. Provisional Application Ser. No. 62/190,462 entitled “METHOD AND SYSTEM FOR PROVIDING ACCESS TO AN ONLINE RESOURCE,” filed on Jul. 9, 2016, incorporated herein by reference in its entirety.

### FIELD OF INVENTION

The present invention relates generally to access management of online resources and methods for receiving payment for usage of those resources.

### SUMMARY

As the technical quality of online content such as streaming video, music, games, and downloadable content increases, the cost of the resources involved in providing that content—including memory, bandwidth, and storage space—rises as well. At the same time, concerns about online security continue to grow. For at least these reasons, controlling who may access online content has become very important.

One arrangement for providing online content involves one entity hosting the content, with another entity—such as a content provider—managing which of its users are allowed to access the content. For example, a content provider may wish to offer a website on which its customers can access embedded interactive video streams. The video streams themselves, however, may be stored and served from a third-party host server. The third party host server may not be concerned with what users are accessing the video streams, so long as the users are authorized by the content provider to do so.

One current approach to handling such an arrangement involves the content provider acting as an intermediary that forwards authorized requests to the third-party host server. Yet such an approach, in addition to being inefficient, may also place an undesirable burden on the content provider. The content provider may not have the capacity to process all such requests during peak times. At slower times, excess capacity goes to waste. Scalability becomes a concern as the amount of content grows, and with it the number of users trying to access that content.

Another approach involves a software application that redirects those who request access to secure content to a Security Token Service (STS), which may be a third party and which is responsible for issuing the proper credentials. Those users who receive the proper security token from the STS can then return to the software application and access the content. This approach takes the administration of security credentials out of the hands of the software application itself, though, whereas the software application may be in the best position to determine access rights.

According to one aspect, it is appreciated that there is a need for a system and method of allowing a content provider to grant its users access to online resources without requiring the content provider to be involved on a transaction-by-transaction basis. It would be desirable to allow the content provider to issue credentials allowing access to online content, while allowing a hosting entity to process requests for that content by those users presenting those credentials without needing to involve the content provider. To this end, according to one aspect of the present invention, a resource provider server provides an access management server (e.g., a content provider) with a unique access token and encryption token. The resource provider can create sets of permissions for its users to access online content hosted by the resource provider server, and use the encryption token to encrypt the access token and the set of permissions. The resulting encrypted token can be distributed to the content provider's users as the content provider sees fit.

A user wishing to access online content hosted by the resource provider server can present this encrypted token, along with the specific request for the online content (e.g., a request to stream a particular online video), directly to the resource provider server. The resource provider server then decrypts the encrypted token, and examines what access rights the token gives to the user submitting the request. If the rights are sufficient to access the requested content, the resource provider performs the requested action on the requested resource.

There is also a need for a method of allowing a user to provide a retainer or prepayment for usage of online resources, with any outstanding balance or refund to be paid after usage fees are calculated at the end of the service period.

According to one aspect of the present invention, a computer-implemented method of providing access to an online resource on a distributed computer system comprising a plurality of clients that access a plurality of resources is provided. The method comprises acts of receiving from a client a resource request containing a requested resource identifier, a requested action identifier, and an encrypted authorization token identifying an access management server, an available resource, and an available action, decrypting the encrypted authorization token using an encryption token, and responsive to the authorization token identifying an authorized access management server, the requested resource identifier identifying the available resource, and the requested action identifier identifying the available action, performing the requested action on the requested resource.

In one embodiment, the method further comprises the act of providing an access token and an encryption token to an access management server, wherein the access token identifies the access management server, and wherein the access token and the encryption token are unique to the access management server. In another embodiment, performing the requested action on the requested resource is responsive to the count of resource requests not exceeding a defined limit of resource requests; further comprising adjusting the count of resource requests. In yet another embodiment, the encrypted authorization token contains a unique grant ID that uniquely identifies the encrypted authorization token.

According to another aspect, a method of granting access to an online resource is provided. The method comprises acts of receiving an access token and an encryption token from a resource provider, wherein the access token and the encryption token are unique to the access server, generating an authorization token containing the access token, an available resource identifier, and an available action identifier, creating an encrypted authorization token using the encryption token, and sending the encrypted authorization token and the access token to a client. According to another embodiment, the authorization token further contains a unique grant ID that uniquely identifies the authorization token.

In another aspect of the present invention, a distributed system is provided comprising an access management server configured to receive an access token and an encryption token and create an encrypted authorization token by encrypting the access token, an available resource identifier, and an available action identifier using the encryption token, wherein the access token and the encryption token are unique to the access management server, and a resource provider server adapted to perform a requested action on a requested resource responsive to receiving a resource request containing the encrypted authorization token, a requested resource identifier matching the available resource identifier, and a requested action identifier matching the available action identifier.

According to another aspect of the present invention, an access management server is provided comprising a first network interface adapted to receive an access token and an encryption token, a first component adapted to generate an authorization token containing the access token, an available resource, and an available action, a second component adapted to generate an encrypted authorization token by encrypting the authorization token using the encryption token, and a second network interface adapted to transmit the encrypted authorization token and the authorization token to a client. According to one embodiment, the first component is adapted to generate an authorization token that further comprises a unique grant ID that uniquely identifies the authorization token.

According to another aspect of the present invention, a method is provided for being compensated for use of an online resource. The method comprising acts of prior to the end of a service period, receiving a first payment from a user, calculating a usage fee for use of the online resource during the service period, applying the first payment against the usage fee, and responsive to the first payment being less than the usage fee, receiving a second payment from the user, wherein the first payment and the second payment are sufficient to cover the usage fee. In one embodiment, the method further comprises an act of, responsive to the first payment being greater than the usage fee, sending a third payment to the user, wherein the third payment is equal to the difference between the first payment and the usage fee. In yet another embodiment, the method further comprises acts of receiving from the user a usage fee limit and responsive to the usage fee being equal to or greater than the usage fee limit, preventing use of the online resource during a remainder of the service period. In another embodiment, calculating a usage fee for use of the online resource during the service period comprises determining a number of minutes the online resource is used during the service period. In yet another embodiment, calculating a usage fee for use of the online resource during the service period comprises determining an amount of computer storage space associated with the user during the service period.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of a system capable of implementing various aspects of the present invention;

FIG. 2 shows a flow chart of an exemplary method for generating a distributed authorization token and providing it to a user;

FIG. 3 shows a flow chart of an exemplary method for generating and processing a resource access token in order to access online content;

FIG. 4 shows a flow chart of an exemplary method for receiving compensation for usage of an online resource; and

FIG. 5 shows a flow chart of an exemplary access management process.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

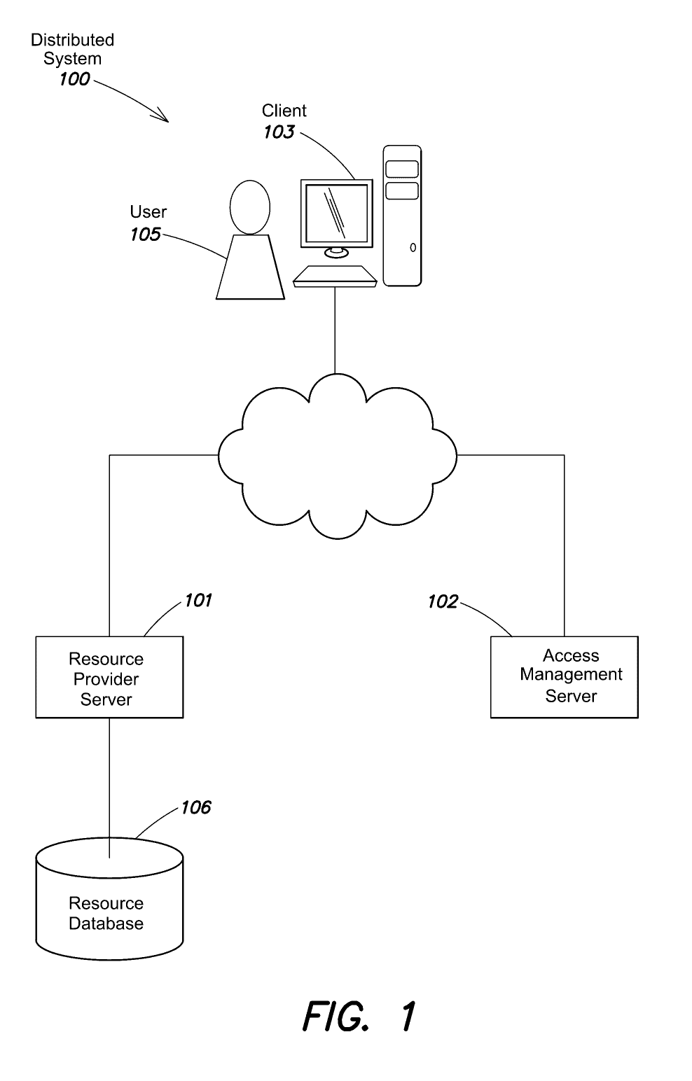

FIG. 1 shows a distributed system 100 in which various aspects of the present invention may be practiced. In particular, a distributed computer system 100 may be provided that allows a user 105 of a client (i.e., computer) 103 to be granted access credentials by an access management server 102, and use those access credentials to access a resource (e.g., a streaming video, a photograph, or social media post) hosted in a resource database 106 by a resource provider 101. The resource provider 101 may host an authorization token database that associates particular clients with the authorizations they have received to perform specific actions on specific online content.

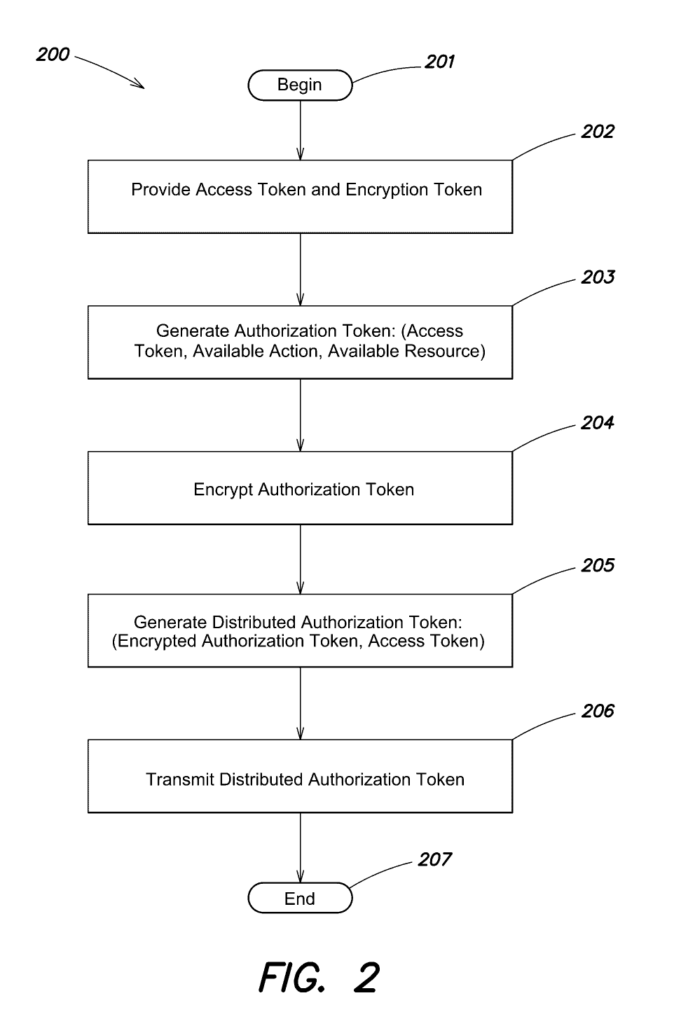

FIG. 2 shows a process 200 for a user to obtain credentials to access an online resource hosted by a resource provider.

At block 201, the process begins.

At block 202, an access token and an encryption token are provided to an access management server. In some embodiments, the access management server and the resource provider may be under common control. In other embodiments, the access management server may be controlled by or associated with an entity (e.g., a social media website) that wishes to provide its users access to online resources, and control the scope of that access, without having to manage or host the online resource itself. For example, a content-oriented website may wish to provide certain users with the option to stream a particular video that is embedded on the website, but hosted (and served from) a third-party resource provider.

The access token provided to a particular access management server may comprise encapsulated data uniquely identifying that access management server. For example, the encapsulated data may include the access management server's IP address, MAC address, unique network or hardware name or other identifier associated with the access management server, or may identify the website, mobile application, or other interface through which the user encounters and accesses the online resource hosted by the resource provider. In other embodiments, the access token may contain a user name, customer number, account number, or other information uniquely identifying the entity that operates the access management server, or some combination thereof. For example, the resource provider may provide an access management server associated with a content-providing website <abc.com> with an access token “abc.com.” For security reasons, it may be desirable that the access token cannot be readily guessed by others, so the identifier of the access management server may contain different or additional information, for example, a string of pseudo-random numbers, such as “abc.com5738923.”

The encryption token may comprise encapsulated data, such as an encryption/decryption key, that may be used by the access management server to securely encrypt authentication data such that only the resource provider (or others with the same encryption/decryption key) can decrypt it later. For example, the encryption token may comprise a key used in symmetric-key encryption specifications such as Advanced Encryption Standard (AES). In other embodiments, the encryption token may comprise a public key used in a public key encryption scheme, or an encryption/decryption key from other encryption/decryption schemes known in the art.

At block 203, the access management server, having received the access token, generates an authorization token including at least the access token, an available-resource identifier, and an available-action identifier. In a preferred embodiment, the authorization token may be thought of as a permission set, establishing the types of actions that users may perform on a given resource associated with a particular access token. This permission set may later be associated with particular clients, giving those clients permission to perform those actions on those resources.

In a preferred embodiment, the authorization token may contain a unique key consisting of one or more attributes that uniquely identify the authorization token. In some embodiments, the unique key may be a unique grant ID, which may be generated as a numerical or alphanumerical value. The unique grant ID value assigned to a given authorization token may distinguish that authorization token from any other authorization token containing the same access token, available-resource identifier, and available-action identifier. In other embodiments, one or more different fields may be used as a unique key.

The available-resource identifier may be an alphanumeric string that identifies, or provides the location of, one or more online resources, or groups of online resources, associated with the resource provider. In some embodiments, the available-resource identifier may provide a Uniform Resource Locator (URL) for an online resource available from the resource provider. In some embodiments, the available-resource identifier may store a shortened form of a URL for the online resource, or may provide a shorter or fixed-length URL that redirects to the URL of the online resource.

It will be appreciated that the available-resource identifier may identify any type of uniquely-identifiable online resource. For example, the online resource may comprise streaming or downloadable audio or video, images, rich content, social media posts or profiles, news headlines, weather conditions or forecasts, blog posts, or the like.

The available-action identifier identifies one or more actions that the access management server may wish to allow a user to perform on the online resource(s) identified by the available-resource identifier. For example, the available-action identifier may indicate that the user is allowed to view, download, edit, or access the URL of the online resource. In some embodiments, specific sub-actions may be specified for the available action. For example, the available-action identifier may indicate that a user who accesses an online streaming video has the option to skip an advertisement appearing before the video, or has the option to view the video in a higher resolution than the default.

In some embodiments, only one available-action identifier may be contained in the authorization token. In other embodiments, multiple available-action identifiers may be packaged together, allowing for a range of available actions.

The authorization token may contain additional information or parameters beyond those already discussed. In some embodiments, the authorization token may provide limits that should be imposed on users, either individually or collectively, who wish to perform the available action(s) on the available resource(s). For example, in some embodiments, the authorization token may contain an expiration datetime, after which the right to perform the available action on the available resource may be revoked. In some embodiments, the authorization token may provide an action limit on the number of times that the available action may be performed on the available resource by any given user. For example, if the action limit k were set to 100, then a user may be allowed to stream an online video no more than 100 times. Such an action limit may be an absolute limit, or may limit the number of actions performed during a particular timeframe or duration. Setting such action limits may be useful in preventing denial-of-service attacks or other attempts, whether intentional or not, to use an excessive amount of the service provider's resources.

At block 204, the access management server encrypts the authorization token using the encryption token provided in block 202, thereby creating a cipher authorization token.

At block 205, the access management server concatenates the cipher authorization token and the (unencrypted) access token provided in block 202, creating a distributed authorization token that is suitable for distributing to users of clients.

At block 206, the distributed authorization token is transmitted to a client. In some embodiments, the client may be identified by the hardware or network address of an end user's computer or other device, and/or by the software running on such a machine. In other embodiments, the client may be identified by a unique identifier of a user of the client, for example, a username, email address, handle, or user number. In some embodiments, the distributed authorization token may be transmitted automatically to the user, such as through a websocket or authentication protocol. In other embodiments, the user may be provided the option of receiving the distributed authorization token before the transmission occurs.

At block 207, process 200 ends.

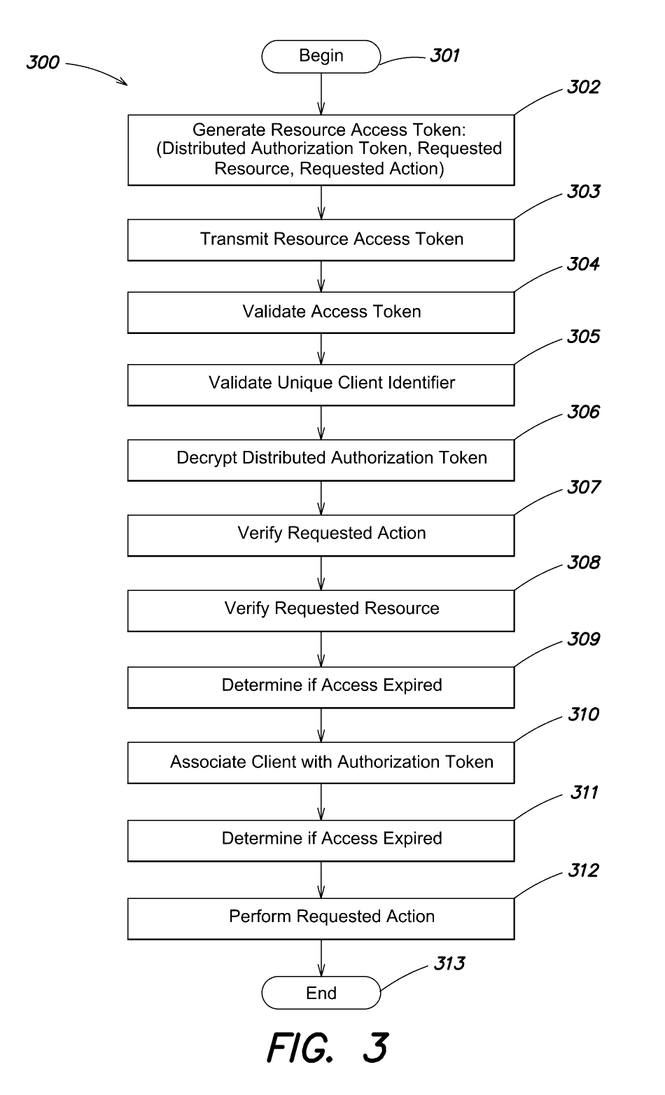

FIG. 3 shows a process 300 for a client user to request that a particular action be performed on a particular online resource, such as streaming of an online video.

At block 301, process 300 begins.

At block 302, in response to an indication that the user would like to perform a particular action on a particular online resource (e.g., a mouse click on an embedded multimedia component in a website), the client generates a resource access token. The resource access token contains the distributed authorization token received by the client at block 206, and also may contain a requested-resource identifier and a requested-action identifier.

The requested-resource identifier may be an alphanumeric string that identifies, or provides the location of, one or more online resources, or groups of online resources, associated with the resource provider on which the user would like to take some action. In some embodiments, the requested-resource identifier may provide a Uniform Resource Locator (URL) for an online resource available from the resource provider. In some embodiments, the requested-resource identifier may store a shortened form of a URL for the online resource, or may provide a shorter or fixed-length URL that redirects to the URL of the online resource.

It will be appreciated that the requested-resource identifier may identify any type of uniquely-identifiable online resource. For example, the online resource may comprise streaming or downloadable audio or video, images, rich content, social media posts or profiles, news headlines, weather conditions or forecasts, blog posts, or the like.

The requested-action identifier identifies one or more actions that the user would like to perform on the online resource(s) identified by the requested-resource identifier. For example, the requested-action identifier may indicate that the user wishes to view, download, edit, or access the URL of the requested-online resource. In some embodiments, the requested-action identifier may specify one or more sub-actions for the available action. For example, the requested-action identifier may indicate that the user wishes to stream an online video, and further wishes to skip an advertisement appearing before the video, or to view the video in a higher resolution than the default.

If the user and/or client have previously submitted a resource access token to the resource provider server, the user may have been assigned and issued a unique client identifier. The unique client identifier may comprise an IP address, MAC address, user name, customer number, account number, or other information uniquely identifying the client and/or a user of the client. In some embodiments, the resource access token generated in block 302 may include such a previously-issued unique client identifier, if one exists. Otherwise, the resource access token may store a NULL or default value for the unique client identifier.

At block 303, the resource access token is transmitted from the client to the resource provider server. In some embodiments, the resource access token may be transmitted automatically to the resource provider server, such as through a websocket, HTTP request, or authentication protocol. In other embodiments, the user may be provided the option of transmitting the resource access token before the transmission occurs.

At block 304, the resource provider determines whether the access token stored in the distributed authorization token (which is in turn contained in the resource access token sent to the resource provide at block 303) corresponds to an authorized access management server. This determination may be made by reference to a database of access management servers, which may indicate whether a particular access management server is an authorized user, and may also store the encryption token associated with a given access token. If the access token does correspond to an authorized management server, process 300 continues. If not, the client's request is rejected.

At block 305, the resource provider server determines whether a valid unique client identifier was provided in the resource access token. The resource provider server may refer to an authorization token database, which may track access rights for particular clients and resources. A record in the authorization token database may store the information found in an authorization token, as discussed above with respect to block 203, and associate that authorization token (and therefore, in some embodiments, the unique grant ID stored therein) with a particular client, thereby indicating that the client has the access rights stored in that authorization token. The authorization token database may also maintain an action counter tracking the number of times that particular client has performed a given action on a given resource during a given time period.

If the unique client identifier provided in the resource authorization token is recognized as valid by the resource provider server, process 300 continues. If an invalid unique client identifier is provided, the client's request may be rejected, or may be treated as NULL. In some embodiments, security precautions may be taken in response to an invalid unique client identifier being provided, such as rejecting all requests from the sender of the resource authorization token for a certain amount of time.

If no unique client identifier is provided in the resource access token, or if the unique client identifier is considered to be NULL, then the resource provider server may generate and store a new unique client identifier to identify the client sending the resource access token. The unique client identifier may comprise an IP address, MAC address, user name, customer number, account number, or other information uniquely identifying the client and/or a user of the client. The generated unique client identifier may be substituted into the resource access token in place of the NULL or invalid unique client identifier. In some embodiments, the unique client identifier may also be transmitted to the client, which may store the unique client identifier to be incorporated in subsequent resource access tokens generated in block 302.

At block 306, the resource provider server attempts to decrypt the distributed authorization token contained within the resource access token. Decryption may be performed using the same encryption token provided to the access management server in block 202. In this way, it can be verified that the distributed authorization token was generated through use of the encryption token, which indicates that the distributed authorization token is valid. If the decryption is successful (i.e., the distributed authorization token is valid), then process 300 continues. If not, the client's request is rejected.

At blocks 307 and 308, the resource provider server determines whether the authorization token, which was extracted and decrypted from the resource token in block 306, allows for the requested action to be performed on the requested resource. For example, if the requested-action identifier corresponded to a “view” action, and the requested-resource identifier corresponded to an online video, the resource provider server would look to the authorization token (within the resource access token) to determine whether a “view” can be performed on an online video. In some embodiments, the requested-action identifier and the requested-resource identifier in the resource access token may be compared, respectively, to the allowed-action identifier and allowed-resource identifier in the authorization token, to determine if they each match.

At block 309, the resource provider server determines if the authorization token contains an expiration datetime and, if so, whether that expiration datetime has already passed. If so, any right to perform the requested action on the requested resource is deemed to have expired, and the client's request is rejected. Otherwise, if the expiration datetime has not yet passed, or if no expiration datetime was contained in the authorization token, process 300 continues.

At block 310, the resource provider server determines whether a record in the authorization token database has already associated the client with the authorization token. If not, a record may be added to the authorization token database, associated the client with the authorization token. In some embodiments, an action counter may also be stored, and may be initialized to 0.

At block 311, the resource provider server determines whether the action counter stored for the client in the authorization token database is equal to or greater than any action limit set in the authorization token itself. If so, the client has exhausted its right to perform the requested action on the requested resource, and the request is rejected. Otherwise, the resource provider server increments the action counter to reflect that the requested action is to be performed on the requested resource.

At block 312, the resource provider server performs the requested action on the requested resource. For example, a requested video may be streamed.

At block 313, the process ends.

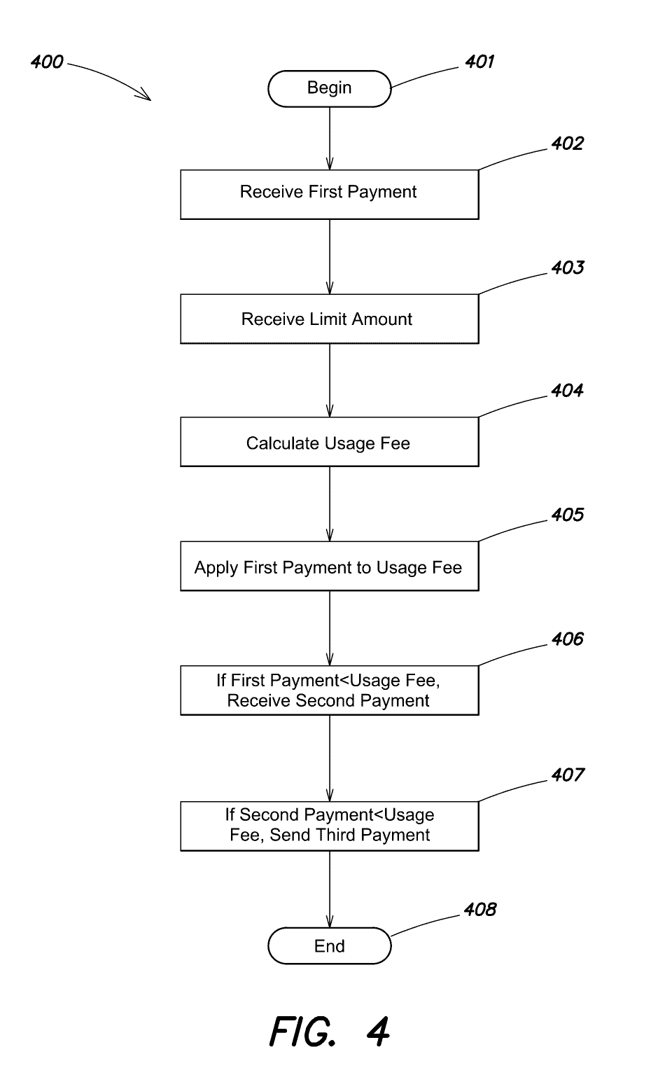

FIG. 4 shows a process 400 for being compensated for use of an online resource.

At block 401, process 400 begins.

At block 402, a service provider receives from a user a first payment, prior to the end of a service period, for usage of an online resource by the user of its customers during the service period. In some embodiments, the first payment may be held in escrow until after the end of the service period. In other embodiments, the first payment may be used for the service provider's benefit during the service period. In some embodiments, the amount of the first payment may be set by the user, and may be based on a budgeted or predicted amount. In other embodiments, the amount of the first payment may be set by the service provider, or may be suggested by the service provider based on preset amounts, historical usage by the user and/or others, or by other pricing arrangements known in the art. The payment may be transmitted by cash, check, credit card, wire transfer, or other known methods of making payments.

At block 403, in some embodiments the service provider receives from the user an indication of a cap or limit, to be imposed on the user or its customers, on the usage of online resources or the costs incurred therefrom. Such a cap may be desirable in the event of unexpectedly high usage of an online resource during the service period, for example by a video “going viral.” In such situations, unexpected usage fees may cause a hardship to the user, who may not have budgeted for them and/or may not have the resources to pay them. This, in turn, may impose the risk of non-payment on the service provider.

The user may be allowed to set any limits on online usage, or may be given one or more options to choose from. In some embodiments, the limit may be adjustable by the user during the service period. As online usage approaches the limit, the user may be provided with advance warning that the limit is being approached. In some embodiments, access to one or more online resources may be blocked or severely limited once the user-defined limit on online usage is reached. In some embodiments, the service provider may “throttle” online usage as the user approaches the limit, to attempt to delay, mitigate, or avoid a complete block of access to the user's online resources.

The length of the service period may be any defined length of time, such as an hour, day, week, month, quarter, year, or any other unit. In some embodiments, the length of the service period may be defined by the service provider. In other embodiments, the user may be allowed to choose a length of the service period.

At block 404, the service provider calculates a usage fee for use of the online resource during the service period. In a preferred embodiment, the usage fee is calculated at or after the end of the service period. In other embodiments, the usage fee may be calculated one or more times during the service period. The usage fee may be calculated or determined according to any number of usage factors known in the art, including the number of minutes (or other duration) that an online resource is being viewed, streamed, or recorded; the amount of computer storage space used by or associated with the user during the service period; the amount of data downloaded or streamed by the user or its customers; the bandwidth allocated to the user; or other factors. The determination of resource usage may be determined, by, for example, and online accounting server.

At block 405, the first payment, received in block 402, is applied against the usage fee calculated in block 404. In some embodiments, where the first payment was held in escrow, the first payment may be transferred from escrow to an account associated with the service provider. The balance of the usage fee may be reduced by the corresponding amount.

In some embodiments, the first payment may be applied against the usage fee such that the usage fee is reduced by more than the first payment, to reflect the fact that the first payment was an advance payment. In this way, the service provider may adjust the credit given for the first payment and incentivize the user to pay a higher first payment, thereby earning revenue earlier and reducing the risk of non-payment or underpayment.

At block 406, the service provider determines if the first payment is less than the usage fee. In other words, the service provider determines whether the first payment is insufficient to cover the user's usage fee, meaning an additional payment is required. If so, the service provider receives a second payment from the user to cover the balance due on the usage fee after adjusting for the first payment. In some embodiments, the user may be sent an invoice for second payment. In other embodiments, the second payment may be withdrawn directly from an account associated with the user.

At block 407, the service provider determines if the first payment is greater than the usage fee. In other words, the service provider determines whether the first payment is an overpayment for the usage fee. If so, the user may be owed a balance or refund. In some embodiments, the user may be given a credit against future first payments or usage fees. In other embodiments, the user may be issued a refund in the form of a check, wire transfer, or credit card chargeback.

At block 408, process 400 ends.

### Distributed Authentication Tokens

As discussed above, there is a problem of granting clients communicating with a server access to resources on an external resource provider without the need for the server to communicate with the resource provider apriori. This may be solved, according to one embodiment, by what is referred to herein as distributed authorization tokens. One primary use-case for distributed authorization tokens are external services that provide resources for clients where the access control to the resources is handled by an independent server.

### EXAMPLE

In one example implementation, an API may be provided that performs video recording and playback. The API may, for example, allow customers to embed a video recorder and player into their website where their clients can then interact with embedded information. In this example, the API provider is the external resource provider, the external resources are video files, the server is the webserver serving the website that embeds the API recorder and player, and the clients are web browsers displaying the website as well as embedded information provided by the API provider.

In this example implementation, assume the following environment: a single resource provider (RP) that grants access and access management rights to independent sets of resources R_1, . . . , R_n to independent access management servers A_1, . . . , A_n. For every access management server A_i, we have clients C_1, . . . , C_m randomly asking for access to resources r in R_i on RP. The management servers A_i have the authority to grant or deny access to any resources in R_i. According to one implementation, all communication channels (i.e. between RP and A_i, between A_i and C_j, between C_j and RP) are assumed to be securely end-to-end encrypted.

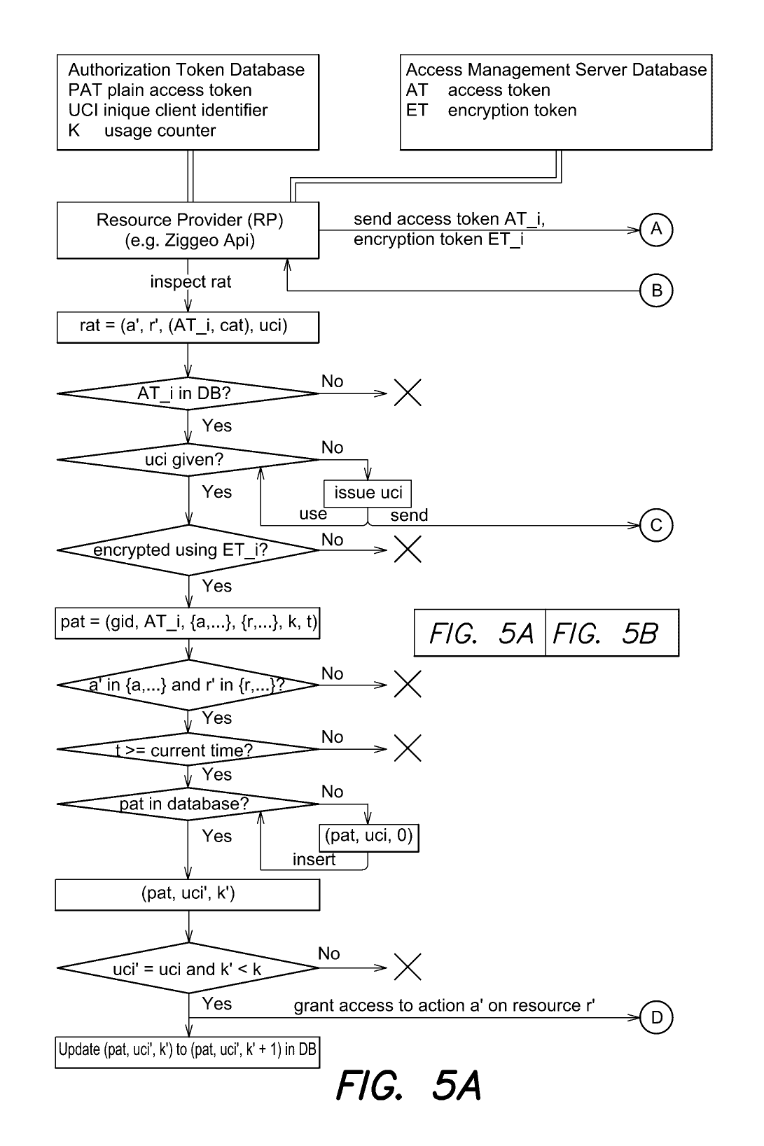

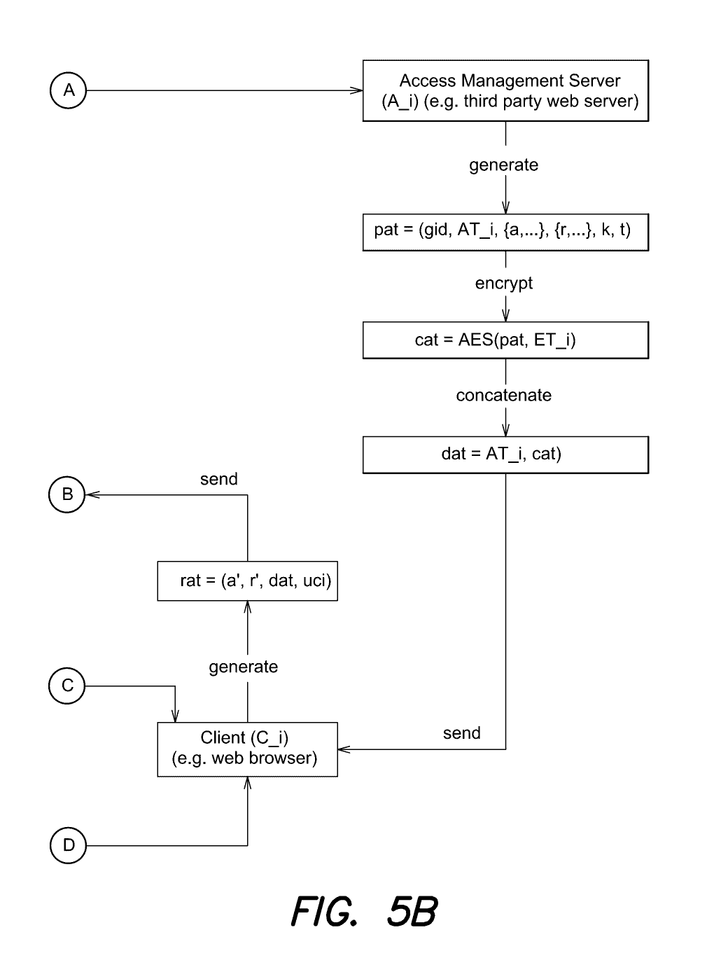

It is appreciated that distributed authorization tokens remove the need for A_i to communicate with RP in order to grant accesses to resources on RP. Such an example process for granting access is shown by way of example in FIG. 5. During setup of an A_i, the RP exchanges two keys with the A_i: an access token (AT_i) that uniquely identifies an A_i, and an encryption token (ET_i). In order to grant a client C_j access to perform actions a, . . . on resources r, . . . k-times, valid until UTC time t, the access management server:
1) Generates a random unique grant id (gid).
2) Generates a tuple (gid, AT_i, {a, . . . }, {r, . . . }, k, t), referred to hereinafter as the plain authorization token (pat).
3) The access management server encrypts the pat by a standard symmetric-key encryption using ET_i like AES, resulting in a cipher authorization token (cat).
4) It concatenates the cat and the AT_i, (AT_i, cat), resulting in a distributed authorization token (dat).
5) It transmits the dat to the client C_j.

In order to gain access to perform action a′ on a resource r′, the client C_j uses the dat and its unique client identifier (uci) (if present, see below) to construct a resource access token (rat), e.g. (a′, r′, dat, uci), and transmits it to the resource provider.

The resource provider keeps a authorization token database. According to one embodiment, each row consists of a plain authorization token, a unique client identifier, a usage counter, e.g. (pat, uci, k). The resource provider, upon receiving a resource access token rat=(a, r, dat, uci)=(a, r, (AT, cat), uci):
1) Checks whether AT is a registered access management server. If not, RP rejects the request.
2) Checks whether an uci is given. If not, issues an uci, transmits it back to the client and overrides the empty uci in the request with the generated uci.
3) Decrypts the dat using the encryption key ET associated with AT. If it fails, RP rejects the request.
4) Checks whether the required action is contained in the granted action set. If not, RP rejects the request.
5) Checks whether the required resource is contained in the granted resources set. If not, RP rejects the request.
6) Checks whether the current UTC time is greater than the valid UTC time in the token. If it is, RP rejects the request.
7) Checks whether the (gid, AT_i)-combination is contained in the database.
a) If it is not contained in the database, it adds (pat, uci, OJ to the database and continues.
b) If it is contained in the database, it checks whether the contained uci′ equals the given uci.
   If it does, it continues, otherwise RP rejects the request.
8) The entry (pat, uci, k′) is looked up in the database. If k′>k, RP rejects the request.
9) RP updates (pat, uci, k′) to (pat, uci, k′+1) in the database.
10) RP grants and/or performs action a on resource r.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer-implemented method of providing access to an online resource on a distributed computer system comprising a plurality of clients that access a plurality of resources, the method comprising acts of:
receiving from a client a resource request containing a requested resource identifier, a requested action identifier, and an encrypted authorization token identifying an access management server, an available resource, and an available action;
decrypting the encrypted authorization token using an encryption token; and
responsive to the authorization token identifying an authorized access management server, the requested resource identifier identifying the available resource, and the requested action identifier identifying the available action, performing the requested action on the requested resource.

2. The method of claim 1, further comprising the act of providing an access token and an encryption token to an access management server, wherein the access token identifies the access management server, and wherein the access token and the encryption token are unique to the access management server.

3. The method of claim 1, wherein performing the requested action on the requested resource is responsive to the count of resource requests not exceeding a defined limit of resource requests; further comprising adjusting the count of resource requests.

4. The method of claim 1, wherein the encrypted authorization token contains a unique grant ID that uniquely identifies the encrypted authorization token.

5. A method of granting access to an online resource, comprising acts of:
receiving an access token and an encryption token from a resource provider, wherein the access token and the encryption token are unique to the access server;
generating an authorization token containing the access token, an available resource identifier, and an available action identifier;
creating an encrypted authorization token using the encryption token; and sending the encrypted authorization token and the access token to a client.

6. The method of claim 5, wherein the authorization token further contains a unique grant ID that uniquely identifies the authorization token.

7. A distributed system comprising:
an access management server configured to receive an access token and an encryption token and create an encrypted authorization token by encrypting the access token, an available resource identifier, and an available action identifier using the encryption token, wherein the access token and the encryption token are unique to the access management server; and
a resource provider server adapted to perform a requested action on a requested resource responsive to receiving a resource request containing the encrypted authorization token, a requested resource identifier matching the available resource identifier, and a requested action identifier matching the available action identifier.

8. An access management server comprising:
a first network interface adapted to receive an access token and an encryption token;
a first component adapted to generate an authorization token containing the access token, an available resource, and an available action;
a second component adapted to generate an encrypted authorization token by encrypting the authorization token using the encryption token; and
a second network interface adapted to transmit the encrypted authorization token and the authorization token to a client.

9. The access management server of claim 8, wherein the first component is adapted to generate an authorization token that further comprises a unique grant ID that uniquely identifies the authorization token.

10. A method for being compensated for use of an online resource, comprising acts of:
prior to the end of a service period, receiving a first payment from a user;
calculating a usage fee for use of the online resource during the service period;
applying the first payment against the usage fee;
responsive to the first payment being less than the usage fee, receiving a second payment from the user, wherein the first payment and the second payment are sufficient to cover the usage fee.

11. The method of claim 10, further comprising the act of, responsive to the first payment being greater than the usage fee, sending a third payment to the user, wherein the third payment is equal to the difference between the first payment and the usage fee.

12. The method of claim 10, further comprising acts of:
receiving from the user a usage fee limit; and
responsive to the usage fee being equal to or greater than the usage fee limit, preventing use of the online resource during a remainder of the service period.

13. The method of claim 10, wherein calculating a usage fee for use of the online resource during the service period comprises determining a number of minutes the online resource is used during the service period.

14. The method of claim 10, wherein calculating a usage fee for use of the online resource during the service period comprises determining an amount of computer storage space associated with the user during the service period.
